(19) United States
(12) Patent Application Publication
(10) Pub. No.: US 2013/0312581 A1
(43) Pub. Date: Nov. 28, 2013

(54) Adjustable slicer and cutter

(71) Applicants: Richard A. St. Pierre, Horsebeads, NY (US); Fletcher W. Chapin, Vestal, NY (US); David W. Dranchak, Endwell, NY (US)

(72) Inventors: Richard A. St. Pierre, Horsebeads, NY (US); Fletcher W. Chapin, Vestal, NY (US); David W. Dranchak, Endwell, NY (US)

(21) Appl. No.: 13/986,299

(22) Filed: Apr. 19, 2013

Related U.S. Application Data
(60) Provisional application No. 61/687,820, filed on May 2, 2012.

(51) Int. Cl. B26D 1/30

(52) U.S. Cl. CPC B26D 1/30
USPC 83/605

(57) ABSTRACT

The present invention provides a family of devices to slice or cut items such as produce and more particularly, even large items such as watermelons safely, cleanly, and efficiently. The invention is scalable and can also be applied to the slicing or cutting of other items including logs. Other embodiments showing extensions to the invention are also disclosed.

### FIELD OF THE INVENTION

The present invention relates to slicing and cutting items such as produce and more particularly, to slicing even large items such as watermelons safely, cleanly, and efficiently. The invention can also be applied to the slicing or cutting of other items including logs.

### BACKGROUND OF THE INVENTION

The cutting and slicing of large objects including foodstuffs as well as other large objects can be both difficult and dangerous. There have been myriad devices, often including a sharp knife, that can effectively cut or slice smaller objects, but when a larger object is present, it is not uncommon for a person to have difficulty effectively operating the prior art devices on the larger objects, or to injure himself or herself. Implementing an easily cleanable, safe and reliable product can be made more difficult for some applications due to the location or working environment.

One possible solution for slicing larger objects is shown by Giessler, in U.S. Pat. No. 7,455,005, which describes a slicing device includes a base for supporting a foodstuff to be sliced and a repositionable knife or blade having a pair of bosses disposed at one end of the blade that extends outwardly away from the blade. The pair of bosses of the blade is coupled to a blade holding rack that acts as a pivot or fulcrum for the blade. The pivot or lever action of the blade permits a user to easily cut through large or hard foodstuff. In one embodiment, the blade is adjustable in the rack to permit a user to lower the blade to make successively deeper slices into and eventually through the foodstuff.

GIESSLER unfortunately has some limitations and concerns that need to be addressed and overcome. For example, since GIESSLER places importance on being able to compactly store the base and rack elements (see FIG. 13), rack 40 is neither intended to nor capable of safely storing blade 30. Even if blade 30 is in an upright position and sitting in rack 40, at least a portion of blade 30 will be exposed, creating a safety concern. The orientation and design (see FIG. 5) of teeth 50 and notches 52 of first recess 48 of rack elements 42 significantly hinder and limit the functionality of device 10. More specifically, with the shape of teeth 50, and the open end of notches 52 being oriented away from the article being sliced, once boss 39 attached to blade 30 is positioned into a particular notch 52, when a user attempts to cut a large article with device 10, blade 30 will have a tendency to want to “cam out” (i.e., push out) of notch 52, making the slicing process very inefficient. To overcome this limitation, GIESSLER (see FIGS. 14-15) requires the user to insert a stop member 64 into channel 54, which blocks an opening of each of the nearby spaced notches 52. Unfortunately if a user needs to change a cutting position to either a higher or lower notch 52, stop member 64 must be lifted in channel 54 and blade 30 moved laterally to dislodge bosses 39, and once blade 30 is in the new cutting position, stop member 64 may be lowered back into channel 54 and cutting can resume, thus rendering GIESSLER rather impractical for cutting large foodstuffs. Furthermore, the necessity of using channel 54 to constrain/retain bosses 39 appears to preclude the possibility of modifying notches 52 to allow additional functionality. It is noted that the numerical designations used hereinabove apply only to GIESSLER and not to the instant invention.

Therefore it would be desirable to have a device that overcomes the abovementioned limitations and concerns in GIESSLER in ways that provide a family of devices that not only can safely slice but also safely cut even large objects cleanly and efficiently without the limitations and concerns of the prior art.

It is therefore an object of the invention to enhance the art of slicing and cutting even larger objects.

It is another object of the invention to provide a scalable family of devices to slice and/or cut objects safely, cleanly, and efficiently.

It is yet another object of the invention to provide a scalable family of devices comprising a cutting device where the cutting device is safely stored out of harm's way when the device is not in use.

It is yet another object of the invention to provide a scalable family of devices where the tip portion of a cutting device works with a control track and spacer of a cutting device positioning member (CDPM) to provide the user of the devices with a mechanical advantage to make slicing and/or cutting an object even easier.

### SUMMARY OF THE INVENTION

The present invention provides a family of devices to slice or cut items such as produce and more particularly, even large items such as watermelons safely, cleanly, and efficiently. The invention is scalable and can also be applied to the slicing or cutting of other items including logs.

### BRIEF DESCRIPTION OF THE DRAWINGS

A complete understanding of the present invention may be obtained by reference to the accompanying drawings, when taken in conjunction with the detailed description thereof and in which:

FIG. 1 is a perspective view of a device to slice or cut items such as produce safely, cleanly, and efficiently in accordance with a first embodiment of the present invention shown in FIGS. 1 - 12;

FIG. 2 is a side view of the cutting device shown in FIG. 1;

FIG. 3 is a top view of the cutting device shown in FIG. 1;

FIG. 4 is a partial exploded view of the device shown in FIG. 1 emphasizing the relative position of some of the components of the CDPM and the positioning of the CDPM to the cutting board;

FIG. 5 is a partial enlarged bottom sectional view of the device shown in FIG. 1 emphasizing the relative position of one of the base portions of the CDPM to the pins of the cutting board once the CDPM is properly secured to the cutting board;

FIG. 6 is a partial enlarged view of the device shown in FIG. 1 emphasizing the catches/detents of the control track of the CDPM in greater detail and showing the positioning of the guide pin/follower on the cutting device to one of the catches/detents of the control track of the CDPM;

FIG. 7 is a sectional side view of the device shown in FIG. 1 with the cutting device in a resting position;

FIG. 8 is a sectional side view of the device shown in FIG. 1 with the cutting device including a guide pin/follower lifted from a resting position, and guide pin/follower moved along a control track in the CDPM to engage a catch/detent but positioned prior to the act of slicing an object;

FIG. 9 is a sectional side view of the device shown in FIG. 8 with the cutting device including a guide pin/follower in the same catch/detent but positioned to show the extent of the slicing motion allowed at this catch/detent;

FIG. 10 is a sectional side view of the device shown in FIG. 8 with the cutting device including the guide pin/follower moved from the previous catch/detent along the control track in the CDPM to engage a second catch/detent and positioned to allow further slicing;

FIG. 11 is a sectional side view of the device shown in FIG. 8 with the cutting device including the guide pin/follower moved from the second catch/detent along the control track in the CDPM to engage the bottommost catch/detent, which has an elongated slot that allows both slicing and cutting of an object, with the guide pin/follower preferably positioned to allow the cutting device yet further slicing;

FIG. 12 is a sectional side view of the device shown in FIG. 11 with the guide pin/follower moved to the catch/detent with an elongated slot to show the cutting device in a typical cutting position;

FIG. 13 is a perspective view of a device to slice or cut items such as produce safely, cleanly, and efficiently in accordance with a second embodiment of the present invention shown in FIGS. 13-16;

FIG. 14 is a partial exploded view of the device shown in FIG. 13 emphasizing the relative position of some of the components of the CDPM;

FIG. 15 is a partial exploded view of the device shown in FIG. 13 emphasizing the catches/detents of the control track of the CDPM in greater detail and the interaction between a tip portion of a cutting device and the spacer, and an alternate control track design;

FIG. 16 is a side view of the spacer shown in FIGS. 13-15;

FIG. 17 is a perspective view of a device to slice or cut items such as produce safely, cleanly, and efficiently in accordance with a third embodiment of the present invention including a modified CDPM and cutting device that offers a possible cost reduction for certain applications;

FIG. 18 is a partial exploded view of the device shown in FIG. 17 emphasizing the relative position of the components of the CDPM and the cutting device;

FIG. 19 is a perspective view of a device to slice or cut items such as produce safely, cleanly, and efficiently in accordance with a fourth embodiment of the present invention including a further modified CDPM as an extension of the CDPM shown in the third embodiment to again offer even a further possible cost reduction for certain applications; and

FIG. 20 is a partial exploded view of the device shown in FIG. 19 emphasizing the relative position of the CDPM and the cutting device.

### DETAILED DESCRIPTION OF THE PREFERRED EMBODIMENT

Generally speaking, the present invention provides a family of devices to slice and/or cut items such as produce including even large items such as watermelons safely, cleanly, and efficiently. The invention can also be applied to the slicing or cutting of other items including logs.

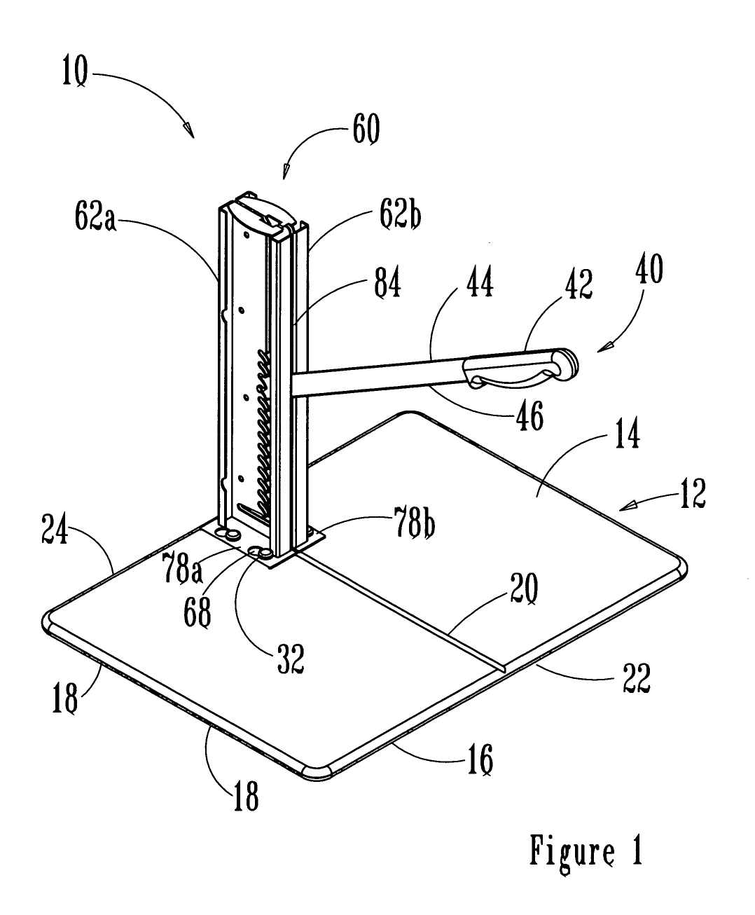

Referring first to FIG. 1, there is shown a perspective view of a device 10 to cut or slice items such as produce safely and efficiently, and be easily disassembled for cleaning. Device 10 is designed to reliably keep a cutting device 40 in an upright position when no external forces are applied to the cutting device, thereby providing a safety feature whereby the cutting device 40 should never act as a guillotine and fall downwardly under the force of gravity alone and potentially causing injury to the user. Device 10 comprises three primary components, a cutting board 12, a cutting device positioning member (CDPM) 60, and cutting device (CD) 40. While variations and innovation in all three of the primary components are disclosed, the greatest amount innovation is in CDPM 60 and its interaction with cutting device 40. Therefore, variations and permutations for cutting board 12 and cutting device 40 will be disclosed in detail in this first disclosed embodiment as will the assembly of all three components, but additional embodiments will concentrate primarily on the differences and improvements of the CDPM's. Device 10 including cutting device 40 may be dimensionally scalable to allow use for smaller objects, or even larger objects such as logs and trees, and the components are made from appropriate materials.

As shown in FIGS. 1, 4 and 7-12, cutting board 12, which is preferably fabricated out of any suitable food-grade material(s) such as but not limited to plastic (e.g., polyethylene), glass or wood, has a substantially planar upper surface 14 for receiving objects or articles to be sliced and/or cut, a generally planar lower surface 16, and a plurality (preferably at least three) of optional feet 18 attached to lower surface 16 of board 12 to help device 10 to remain level and stable by adapting for potential warpage of board 12 or the surface that device 10 is resting on (not shown).

Upper surface 14 may include a groove 20 extending from a front peripheral edge 22 toward a back peripheral edge 24 of board 12, allowing cutting device 40 to slice or cut completely through an article positioned on board 12, if desired. Board 12, which functions as and may also be referred to as a base, may optionally include a trough 26 (not shown) preferably positioned around the perimeter of upper surface 14 to catch or trap liquids or debris from the article being sliced or cut. Trough 26 may even be connected to groove 20 to remove fluid away from groove 20. While upper surface 14 is preferably is textured and relatively flatter than the recessed area of trough 26, it should be understood that upper surface 14 may include variations including dimensional changes to accomplish added functionality.

Board 12 may optionally include measuring means such a scale or ruler (not shown), either as an add-on or formed as an integral part of upper surface 14 of board 12. The measuring means may be in English or metric units, or even in other non-traditional units depending on the particular application. Board 12 may be also implemented with computer numerically controlled (cnc) capability (not shown) to allow even more precise cutting and slicing of objects. One or more carrying handles (not shown) that may be made of a material such as metal, plastic or wood, can be attached to board 12, or can be formed by removing material from board 12. While upper surface 14 of board 12 is preferably substantially planar in this embodiment, even a portion of upper surface 14 and lower surface 16 may have other shapes (e.g., a concave upper surface) to improve performance, add functionality, etc. It should also be understood that in certain applications, for example one that would include the cutting of logs or trees, the implementation of a “board” may be significantly different, since CDPM 60 could even be attached or anchored to something different such as the log being cut or sliced, as long as it provides the necessary support for CDPM 60 and cutting device 40 to properly function.

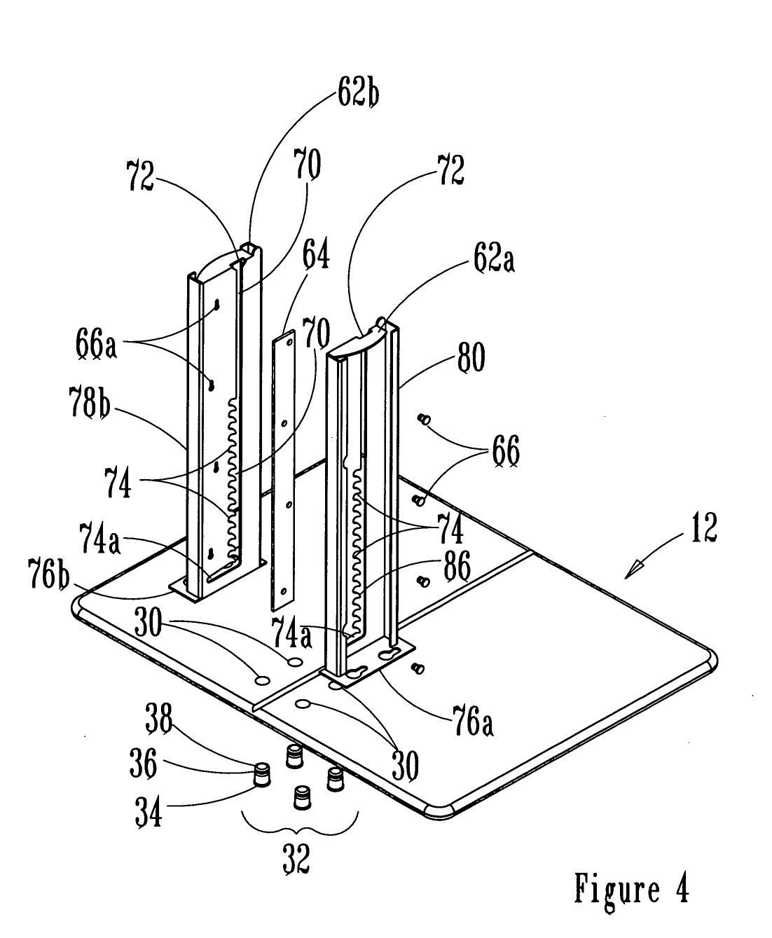

Referring now to FIGS. 1 and 4, board 12 also includes a plurality of holes or openings 30 to help retain a corresponding plurality of base pins 32. Holes 30 typically extend from upper surface 14 to lower surface 16 and may be realized in make different shapes. For example, it may be desirable for holes 30 to include a larger opening 28 (not shown) closer to lower surface 16 to allow base pins 32 to be placed into corresponding holes 30 initially first through lower surface 16. Larger openings 28 provide improved retention for base pins 32 and minimize the possibility of being inadvertently “pulled through” board 12, while still allowing the lower surface 16 of cutting board 12 to preferably be substantially planar.

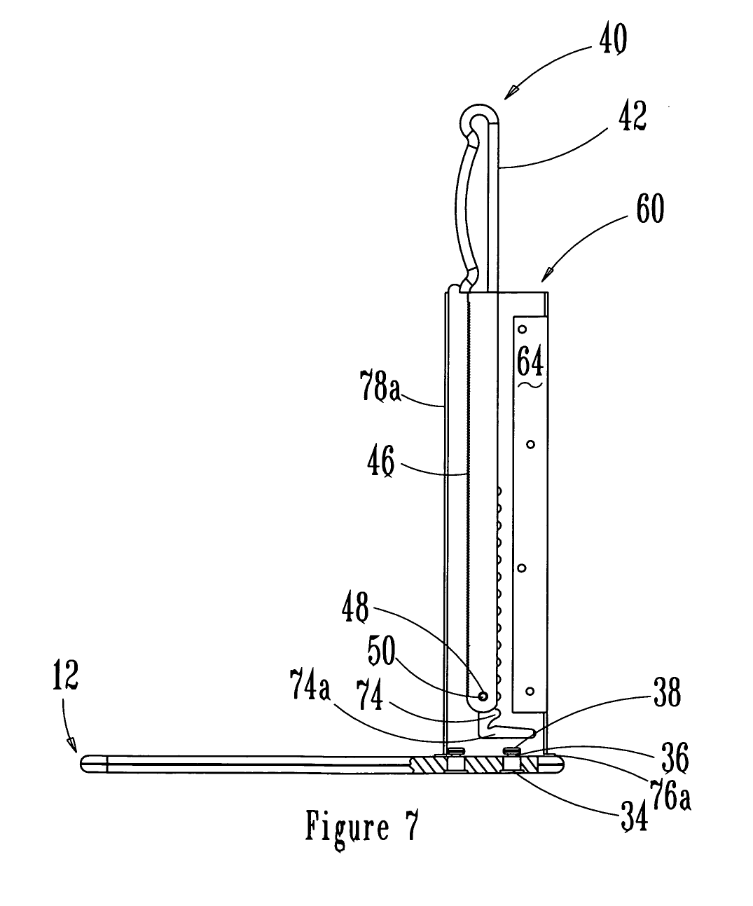

Referring also to FIGS. 7-12, base pins 32 preferably are made of a material such as stainless steel, and are press fit into holes 30 and retained, but they also could be molded into board 12, screwed into holes 30, etc. depending on the application. The pattern or configuration formed by the spacing and placement of locations of holes 30 and base pins 32 is intended to provide a “keying” so that CDPM 60 can always be easily but accurately placed and oriented with respect to cutting board 12, and safely retained to prevent the possibility of improper assembly of CDPM 60 to board 12 and to further ensure that device 10 will operate properly and safely.

In this embodiment there are four base pins 32, each round in shape and having a base section 34, a necked down region 36, and a head 38, and necked down region 36 and head 38 both protrude above upper surface 14 of board 12. Base sections 34 of base pins 32 are preferably recessed to be substantially flush with the lower surface 16 of board 12. The quantity and both the specific as well as relative size and shape of each component of base pins 32 may be varied to accomplish various design goals.

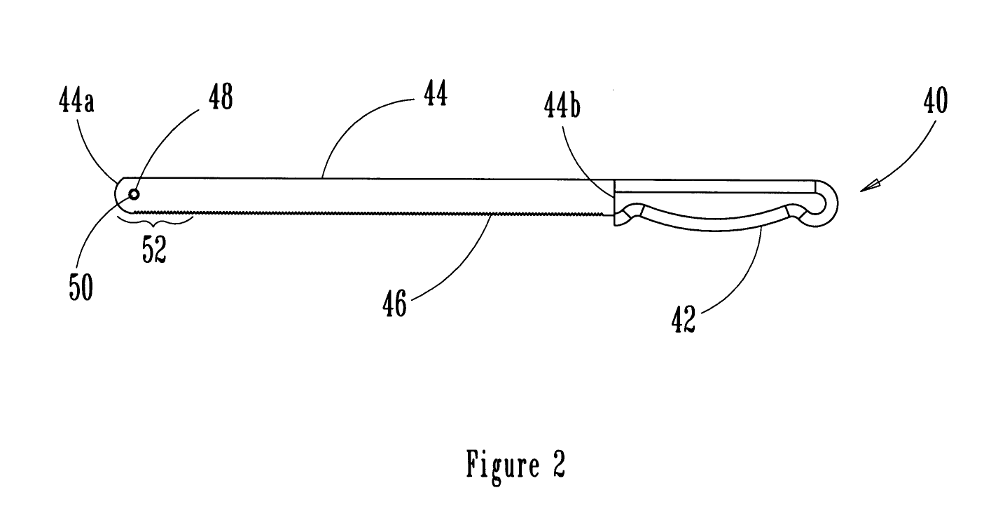

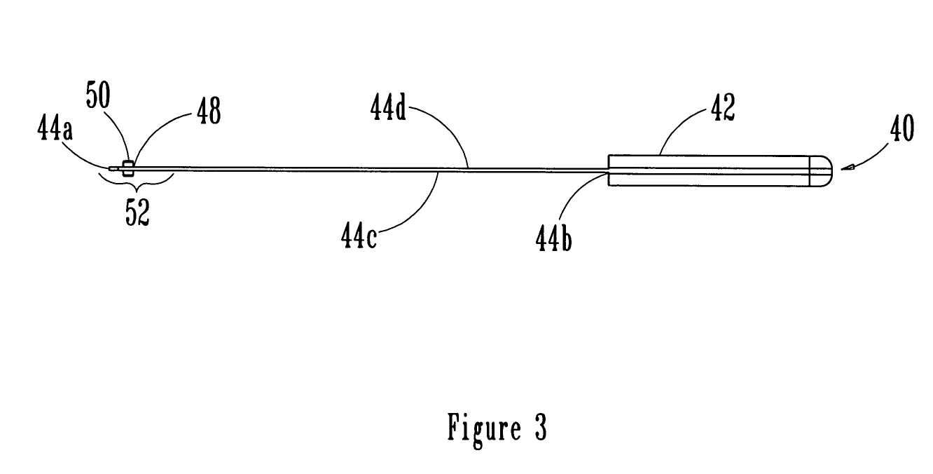

Referring to FIGS. 1-3, cutting device 40 comprises a handle or other gripping means 42, and a preferably elongated blade 44 having a major axis and a first end 44a and a second end 44b, and a first side 44c and a second side 44d parallel to the major axis. A cutting/slicing edge 46 that is preferably serrated is provided along an edge of blade 44 along the major axis, and blade 44 has at least one guide pin hole or opening 48 which receives guide pin or follower 50 preferably located on a tip portion 52 of blade 44. While hole 48 is a through hole in this embodiment, it may be implemented in different ways (e.g., as a partial hole, a threaded hole, etc.) depending on the application and the preferred implementation. Guide pin 50 is preferably press fit into hole 48 in blade 44 of cutting device 40, although it also could be attached by other means such as welding, or even formed as a part of blade 44, in which cases hole 48 may be unnecessary. Guide pin 50 could even comprise a plurality of guide pins (e.g., two) located independent of one another depending on the application and the design of the mating components. Blade 44 of cutting device 40 is preferably made from stainless steel, although many other materials may also be used depending, of course, on the acceptability of the material's properties for the given application.

Cutting device 40 may be inserted and stored in CDPM 60 once CDPM 60 is properly attached to base 12, and handle 42 may provide functionality as a stop. The location and position of guide pin 50 on blade 44 helps to prevent improper assembly of cutting device 40 to CDPM 60 and also influences the specific amount and shape of the cutting action of cutting device 40.

The cutting/slicing edge portion 46 of cutting device 40 may include features such as but not limited to serrations to improve or enhance the performance of cutting device 40 for a given application.

Cutting device 40 may comprise more than one section of cutting/slicing edge (not shown) that can be either the same, or more likely different than cutting edge 46, may be located along the long edge opposite of and parallel to cutting edge 46, and will allow cutting device 40 to provide additional cutting and slicing features or longevity. This enhanced version of cutting device 40 could be used in a rotated orientation compared to the default position of cutting device 40 if handle 42 is appropriately formed and if hole 48 and guide pin 50 were appropriately located.

It may also be desirable that pin 50 be part of a unit attachable to a standard knife (not shown), thus allowing the user the freedom to choose from a wider range of existing cutting devices as long as the new cutting device and attachable unit are dimensionally and materially compatible with CDPM 60.

Cutting device 40 may be implemented in other ways including but not limited to similar to a coping saw consisting of a thin, light blade or wire held under tension, in a U-shaped frame that includes an appropriate modification to handle 42, or also as an electric knife with appropriate modifications.

The design of the various components of cutting device 40 may vary depending on the particular application without departing from the spirit of the invention.

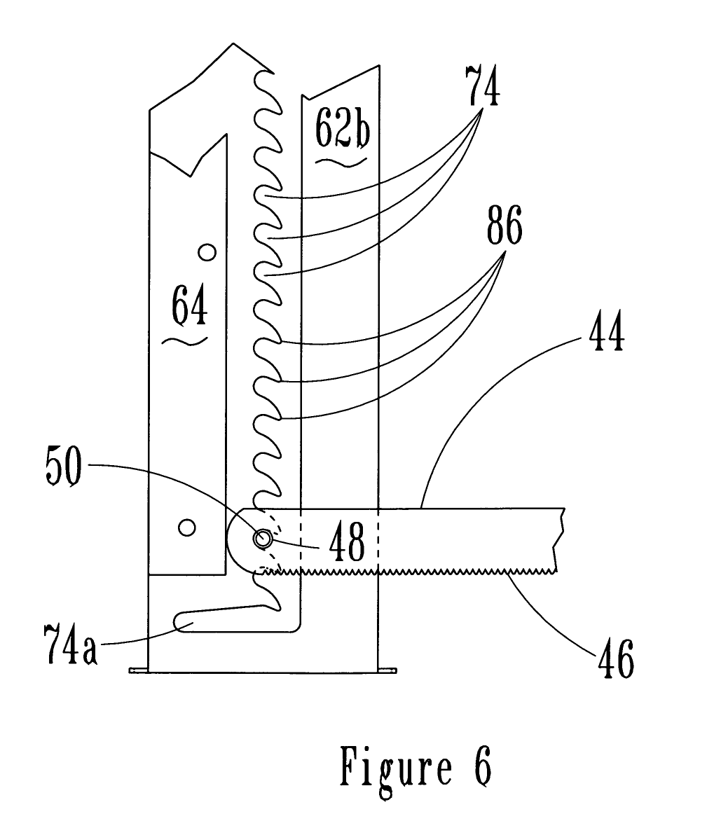

Referring now to FIGS. 1 and 4-6, CDPM 60 provides functionality as a slotted guide and it comprises a channel 84 and a control track 70 to retain and guide cutting device 40 through being proximate guide pin or follower 50 of cutting device 40 and to guide and control the various cutting and slicing motions of cutting device 40. In this embodiment, CDPM 60 comprises three primary components: two complementary slotted guides 62a and 62b and a spacer bar 64 in between. Slotted guides 62a and 62b provide mechanical strength to CDPM 60. Spacer bar 64 could also be integrated into slotted guide 62a or 62b and can be designed to provide additional functionality. These three components are held together in this embodiment by a plurality of slotted pins 66 that are preferably made of a compatible metal, and can be welded, press fit, molded, cast, etc. to at least one of slotted guides 62a and 62b, and each mate with a corresponding keyhole 66a in the other slotted guide 62a and 62b. The three components and pins 66 are preferably made from a material such as but not limited to 300-series stainless steel, which has a higher nickel and chrome content. The design of the three primary components of CDPM 60 improves the ease of safely inserting cutting device 40 into CDPM 60. CDPM 60 is designed to be readily assembled and disassembled to allow the components to be easily yet thoroughly cleaned and dishwasher safe.

It is preferable that the width of spacer 64 be wide enough so that inner surfaces of slotted guides 62a and 62b are spaced apart a sufficient distance to form channel 84 and avoid having cutting device 40 bind against slotted guides 62a and 62b, but not so loose that there is a significant amount of “play”, “wobble” or rotational movement/twisting of cutting device 40. The width of spacer 64 can be adjusted to accommodate cutting devices 40 of various widths.

The design of control track 70 provide a significant improvement over the prior art defined hereinabove. Control track 70 is preferably located in at least one of one of the two slotted guides 62a and 62b and it can be formed in many ways including etching, milling, and as part of a casting process.

In this embodiment control track 70 provides a path comprising an opening 72 that allows guide pin 50 of cutting device 40 to be inserted onto control track 70. The design of opening 72 is intended to make it easier for CDPM 60 to receive guide pin/follower 50 on tip portion 52 of cutting device 40. Once guide pin/follower 50 on tip portion 52 of cutting device 40 is inserted into opening 72 of CDPM 60, pin/follower 50 may be moved along track 70 between the plurality of catches or detents 74 and 74a thereby allowing cutting device 40 controlled passage by a user through channel 84 formed between slotted guides 62a and 62b. In this embodiment opening 72 is located on the top outer/external surface of CDPM 60, but locating it on a different external surface or adding an additional opening is also possible without departing from the spirit of the invention. For example, an additional opening 72a (not shown) could be added on CDPM 60 preferably far away from opening 72 on the outer surface of CDPM 60 facing the user and the object to be sliced or cut. Additional opening 72a allows cutting device 40 to be easily inserted without needing to lift pin 50 of cutting device 40 as high vertically. And while cutting device 40 may also be removed through opening 72a, it is preferable for opening 72a to have retentive means (not shown), to avoid the inadvertent removal of cutting device 40 from control track 70 of CDPM 60.

The preferred “shape” of track 70, including the “width” or spacing of catches/detents 74 and 74a, is designed so that pin/follower 50 on cutting device 40 can move along track 70 in a controlled fashion and will neither bind nor twist along the desired or preferred path and between and into catches/detents 74 and 74a, thus allowing cutting device 40 to easily and safely pivot around pin 50 and accomplish the task at hand. The width of control track 70 does not need to be perfectly uniform in width, but it should be uniform enough that the pin/follower 50 does not come out of track 70 when cutting device 40 is inserted into CDPM 60.

A preferred overall “shape” for track 70 including catches/detents 74 and 74a is to have fairly rounded curves that allow pin/follower 50 to be able to smoothly engage and disengage catch/detent 74 and 74a and not be inadvertently disengaged or forced out while the user is attempting to slice an object with cutting device 40. But it is also preferable that the entry portion of catches/detents 74 and 74a comprise a tooth 86 with a claw hook-shaped portion located to help retain guide pin/follower 50 once engaged within a particular catch/detent 74 and 74a. Spaced teeth 86 and catches/detents 74 and 74a may be cleaned of any foodstuff that may accumulate during cutting or slicing once CDPM 60 is disassembled.

The shape and length of catch/detent 74a is of additional significance because in addition to allowing cutting device 40 to operate in a slicing motion around a pivot point as in the other catches/detents 74, it impacts the length and shape of the stroke of the primarily horizontal “sawing” or cutting motion that cutting device 40 is allowed.

In this embodiment control track 70 of CDPM 60 comprises only one catch/detent 74a that has an elongated slot that allows both slicing and cutting of an object. It should be understood that control track 70 could include multiple catches/detents 74 and/or catches/detents 74a with different spacing, length or shape slots, or other modifications to tailor device 10 to better accomplish specific applications without departing from the spirit of the invention.

An important advantage of the design of CDPM 60 over the prior art is the capability of CDPM 60 to ensure that when pin 50 of cutting device 40 is positioned in one of catches or detents 74 or 74a, an additional component such as a “stop member” (as previously discussed hereinabove) is not necessary to hold guide pin 50 within one of catches or detents 74 or 74a for cutting device 40 to operate effectively and efficiently.

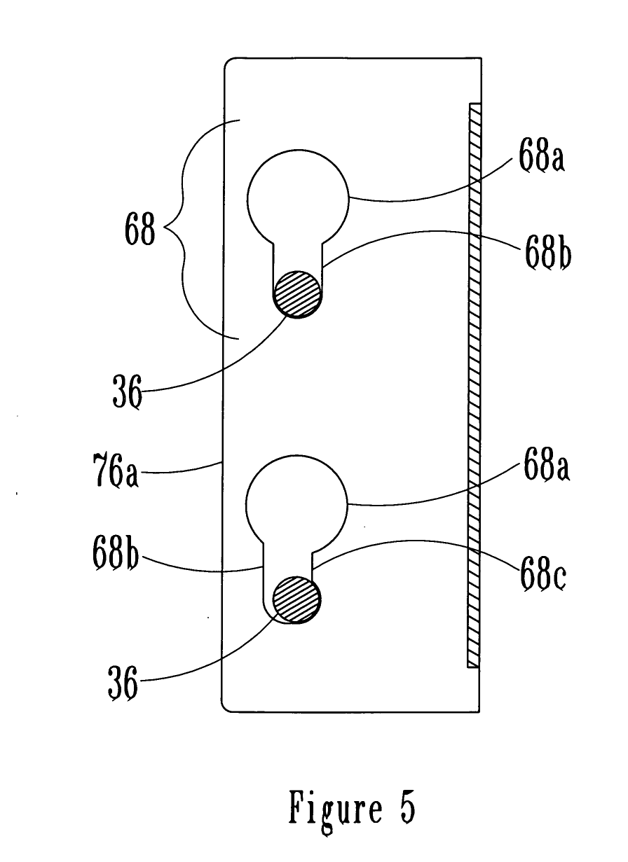

Referring especially to FIGS. 4 and 5, in this embodiment each slotted guide 62a and 62b has a respective base portion 76a and 76b perpendicular to respective substantially vertically standing portion 78a and 78b, and base portions 76a and 76b each comprise two keyholes 68. The assembled CDPM 60 is removably secured to board 12 by positioning the larger portion 68a of keyholes 68 in respective base portion 76a and 76b of slotted guides 62a and 62b of CDPM 60 over corresponding base pins 32 in board 12. CDPM 60 is engaged and retained by retention tab 68c, which is included in at least one keyhole 68, by moving CDPM 60 relative to board 12 until necked down region 36 of base pins 32 are positioned in the smaller portion 68b of keyholes 68. Thus, once properly attached, CDPM 60 is in proper position to allow the insertion of cutting device 40 and for the proper functioning of device 10. Other ways of the aligning and retaining CDPM 60 to board 12 should be apparent to those skilled in the art without departing from the spirit of the overall invention. CDPM 60 may optionally include a feature (not shown) where board 12 is designed so that CDPM 60 cannot be attached to board 12 if cutting device 40 is already inserted in CDPM 60. CDPM 60 may also be attachable to a portion of board 12 that is rotatable (a feature not shown in this embodiment) to allow an angular cutting and slicing action.

CDPM 60 may optionally include an outer cover 82 (not shown) around CDPM 60. Cover 82 provides a protective layer for slotted guides 62a and 62b and may be decorative as well, and it does not interfere with the functionality of CDPM 60. In one embodiment, cover 82 is implemented as two pieces, each covering slotted guides 62a and 62b respectively by being inserted over the top of CDPM 60. Cover 82 may be made of many different materials including metal and plastic, and include decorative features including but not limited to colors, designs and patterns. CDPM 60 may also include a safety latch (not shown) to ensure that when cutting device 40 is in a resting position, it cannot be inadvertently removed.

FIGS. 7-12 are intended to demonstrate the operation of device 10 in greater detail both prior to and during typical use. It should be understood that the following description describes one particular sequence of actions for using device 10, but this is by no means intended to be the only way to effectively and properly use device 10.

Referring primarily to FIG. 7, cutting device 40 may be held upright and safely stored out of harm's way when device 10 is not in use by being positioned vertically downward and resting on the top surface of CDPM 60, and guide pin 50 of cutting device 40 is located toward the part of control track 70 located closer to cutting board 12.

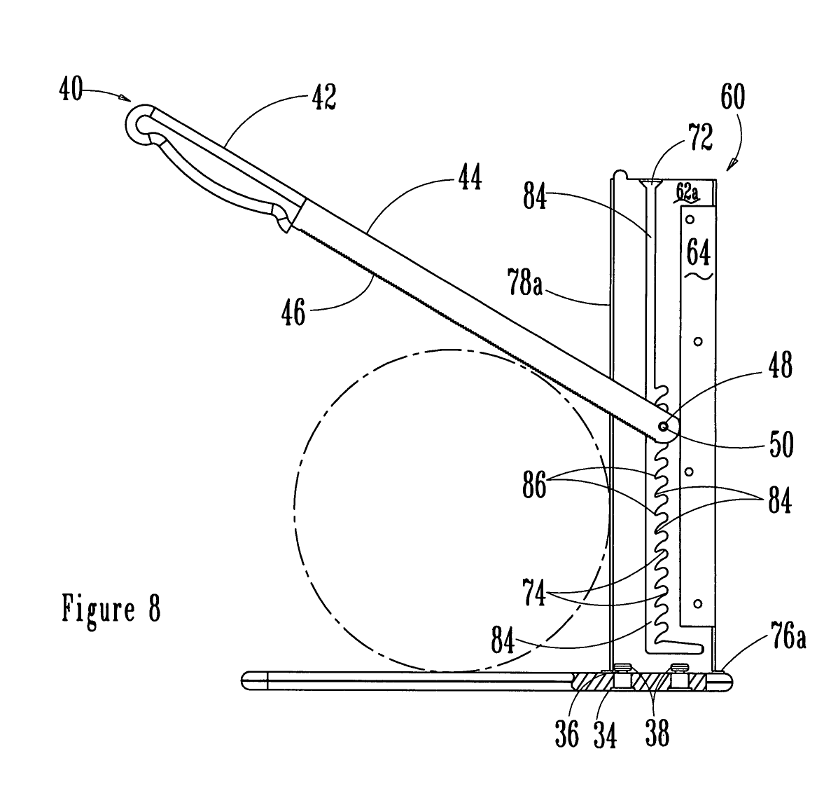

Referring now to FIGS. 7 and 8, once an object to be sliced or cut has been securely placed on cutting board 12, a user's initial action to operate device 10 is to lift handle 42 of cutting device 40 in an upward direction at least far enough to allow handle 40 to clear the top of CDPM 60 and also to allow guide pin/follower 50 on cutting device 40 to move along control track 70 and to engage and pivot on a catch/detent 74 and begin moving in a downward direction toward the user, continuing until cutting edge 46 of cutting device 40 contacts the surface of the object/article to be sliced. Initiating a slicing action with cutting device 40 tends to raise guide pin/follower 50 upward along track 70 away from the user, and guide pin/follower 50 will typically move into the next higher catch/detent 74. Once guide pin/follower 50 is engaged in the next higher catch/detent 74 forming a pivot point and thus allowing the user to slice using a downward motion with cutting device 40. Generally speaking, the motion to move guide pin/follower 50 on cutting device 40 within control track 70 to a higher or lower catch/detent 74 or 74a (to allow the slicing and/or cutting of an object or article) can be described as a “ratcheting” motion.

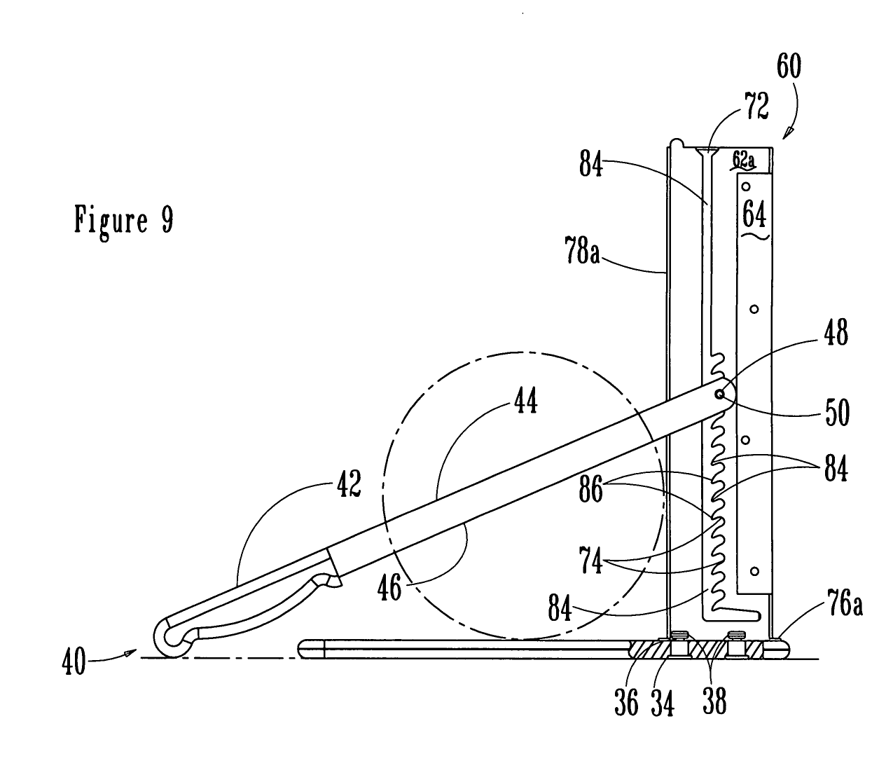

Referring now to FIG. 9, the maximum amount that cutting device 40 is allowed to travel or move in this embodiment is dependent on how the user moves cutting device 40 upward about pin 50 and downward until handle 42 of cutting device 40 contacts cutting board 12, or until the density of the object being sliced is dense enough that the user decides it is prudent or necessary to move guide pin/follower 50 on cutting device 40 to a lower catch/detent 74 to gain additional leverage/mechanical advantage to make slicing the object even easier.

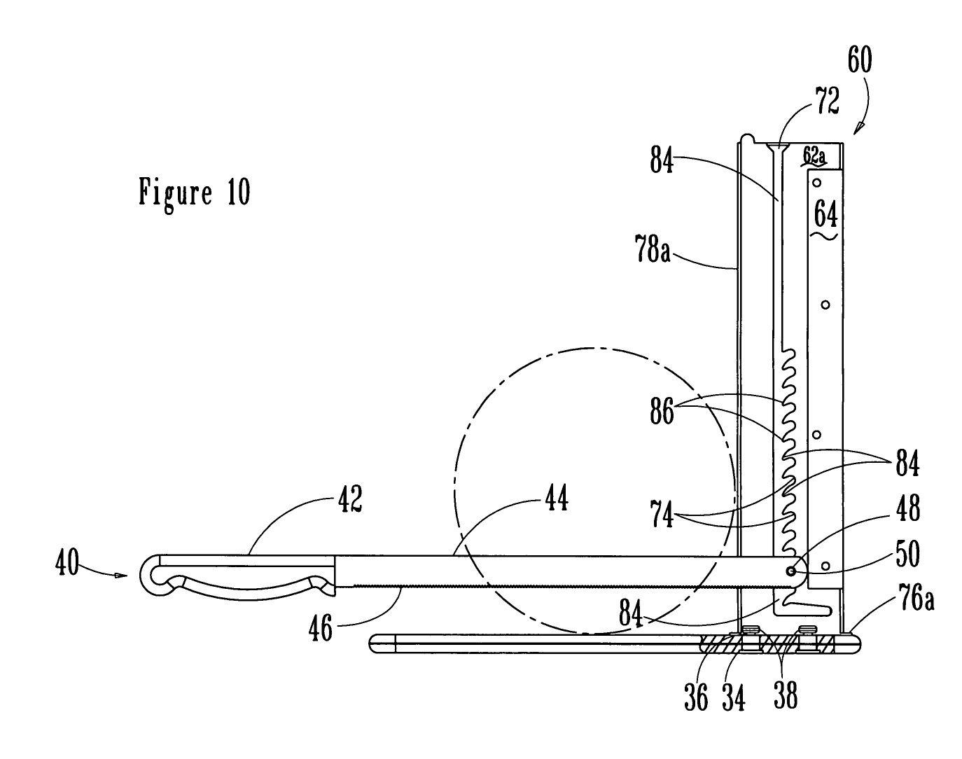

Referring now to FIG. 10, once handle 42 of cutting device 40 contacts cutting board 12, or the user decides it is prudent or necessary to move guide pin/follower 50 on cutting device 40 to a lower catch/detent 74 to continue slicing the object, the user may lift handle 42 of cutting device 40 to allow guide pin/follower 50 on cutting device 40 to disengage from the catch/detent 74 and to move further down (i.e., to ratchet down) along control track 70 to finally engage in and pivot on another catch/detent 74 as shown and described in FIGS. 8 and 9 hereinabove.

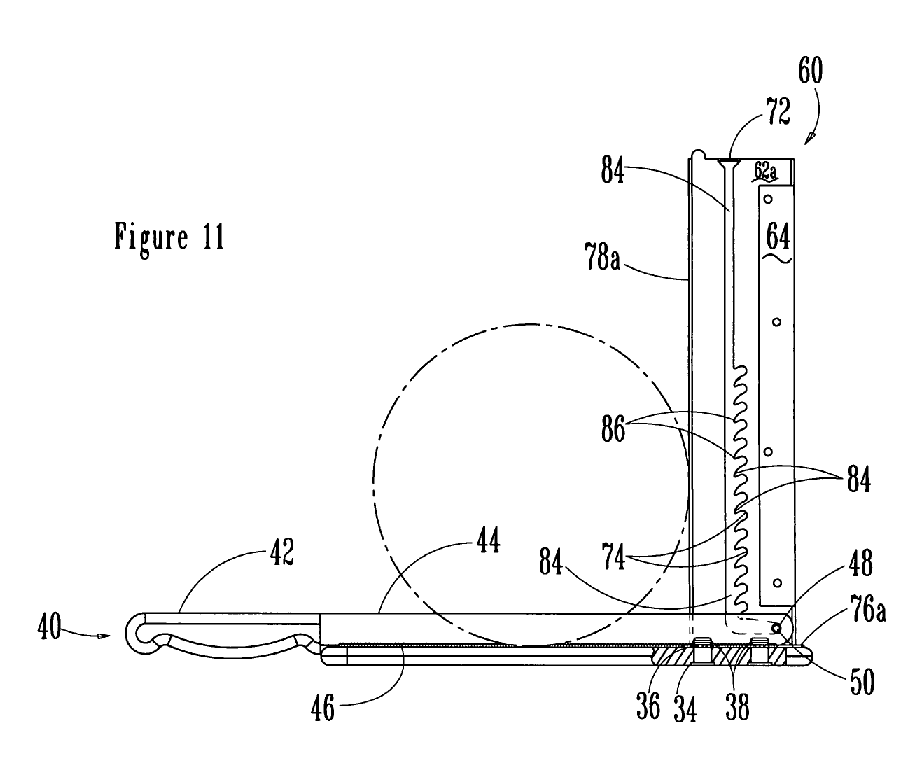

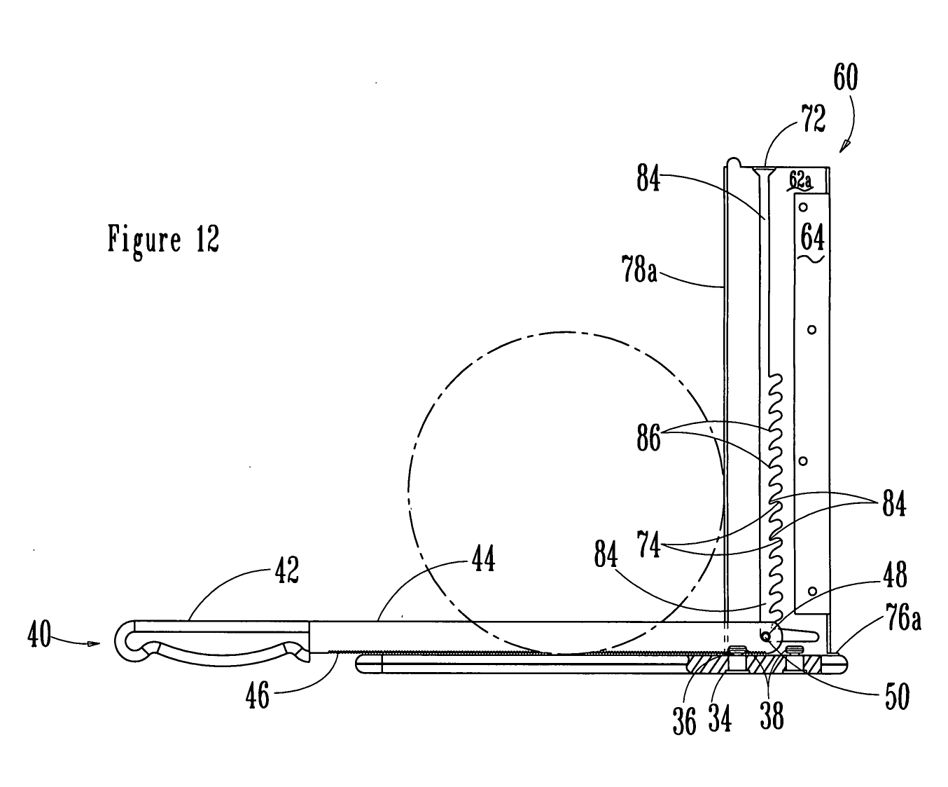

Referring now to FIGS. 11 and 12, once handle 42 of cutting device 40 again contacts cutting board 12, or the user again decides it is prudent or necessary to move guide pin/follower 50 on cutting device 40 to a lower catch/detent 74 or 74a to complete slicing or cutting the object, the user may lift handle 42 of cutting device 40 to allow guide pin/follower 50 on cutting device 40 to disengage from the catch/detent 74 and to move further down (i.e., to ratchet down) along control track 70 to finally engage in and pivot on, for example, catch/detent 74a. FIG. 11 shows cutting device 40 in a position while in catch/detent 74a to slice the object, while FIG. 12 shows cutting device 40 in a position while in catch/detent 74a to cut the object. So overall, this process typically continues until the object is cut or sliced as desired.

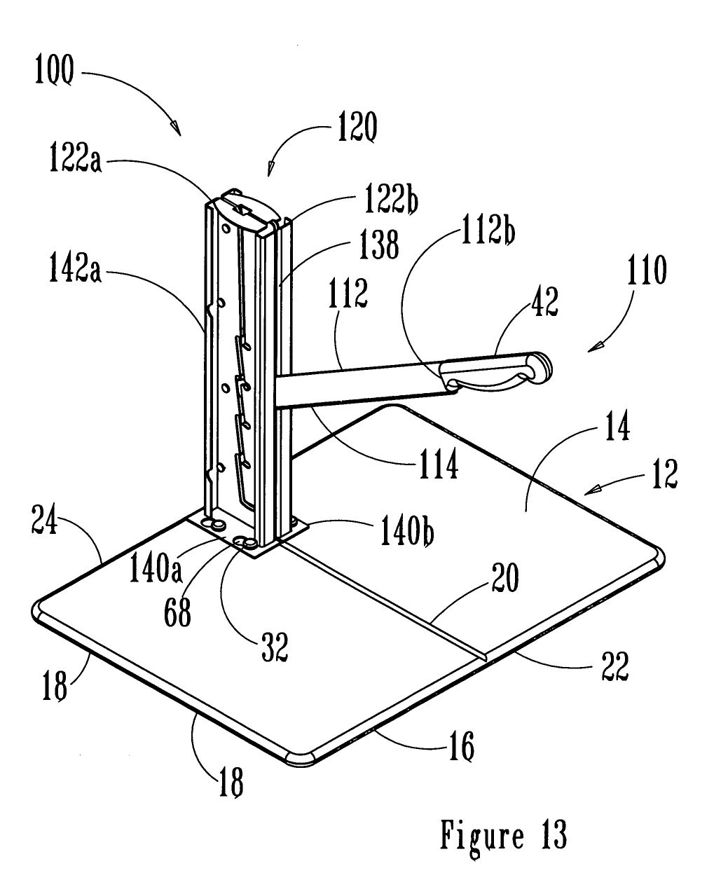

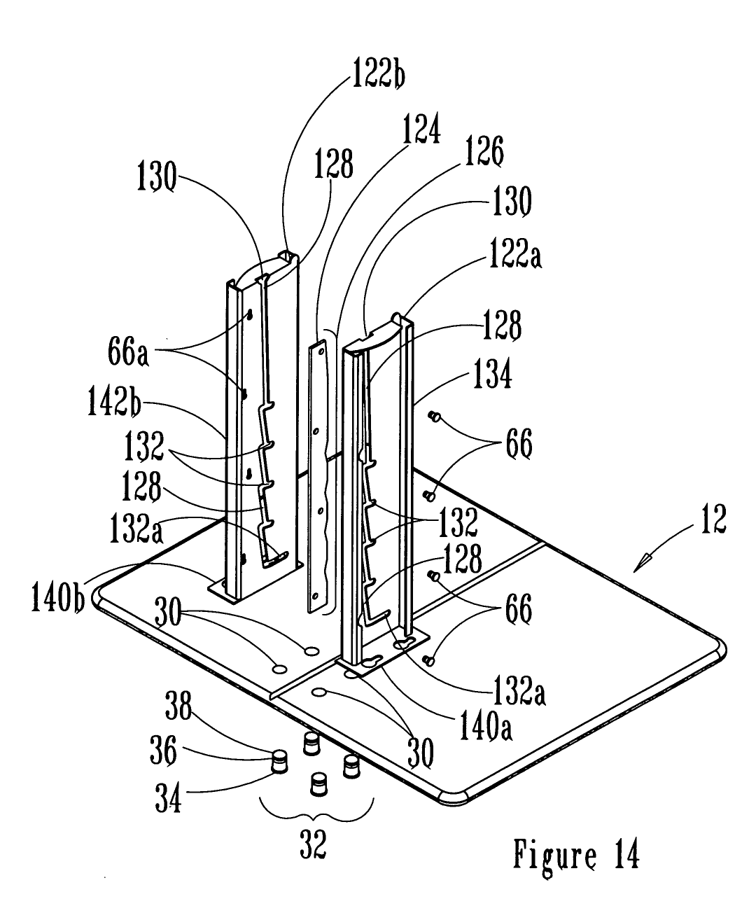

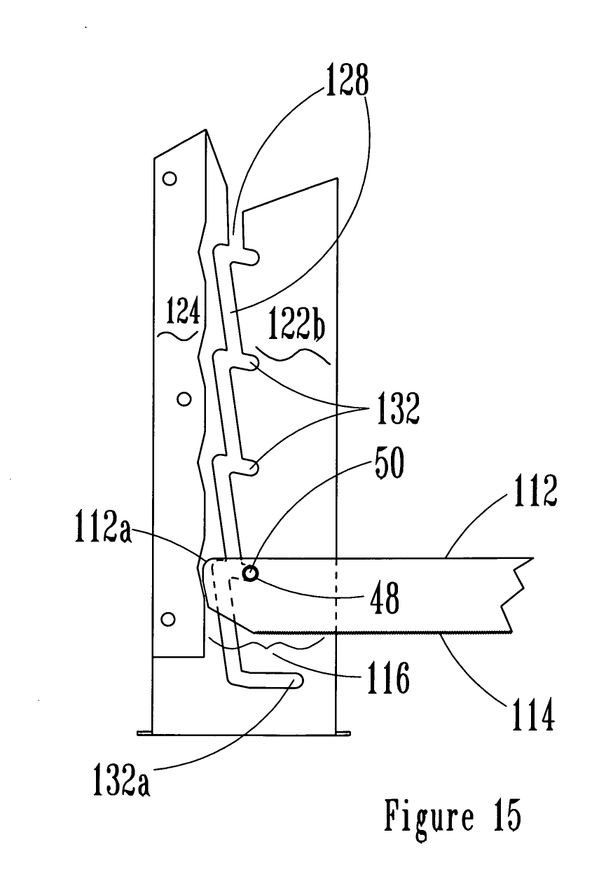

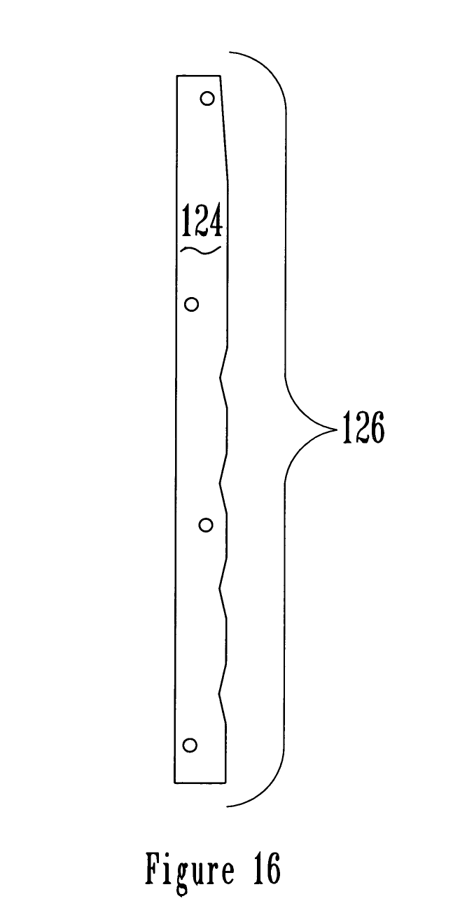

Referring now to FIG. 13, there is shown a perspective view of a device 100 to cut or slice items such as produce safely and efficiently and be easily disassembled for cleaning in accordance with a second embodiment of the present invention. Device 100 (see FIGS. 13-16) is designed to reliably keep a cutting device 110 in an upright position when no external forces are applied to the cutting device, thereby providing a safety feature whereby the cutting device 110 should never act as a guillotine and fall downwardly under the force of gravity alone and potentially causing injury to the user. Since device 100 shares many similarities with device 10, many components used in this embodiment have the same numbers as in the first embodiment also share the characteristics, materials, options, permutations, etc. of those components as well.

As with device 10, device 100 comprises three primary components, a cutting board 12, a cutting device positioning member (CDPM) 120, and a cutting device (CD) 110. A few of the primary differences with the previous embodiment are the shape of a control track 128, and the shape of a front camming edge 126 on a spacer 124 and its interaction with a modified tip portion 116 of a blade 112 on cutting device 110. The design and interaction between front camming edge 126 and tip portion 116 of cutting device 110 in conjunction with the design of control track 128 and the movement of guide pin 50 along control track 128 and into a catch/detent 132 provide for a camming action that improves the mechanical performance and efficiency of device 100.

Cutting device 110 comprises a handle or other gripping means 42, and a blade 112 having a first end 112a and a second end 112b, and a first side 112c and a second side 112d. A cutting edge 114 that is preferably serrated is provided along an edge of blade 112, and blade 112 has at least one guide pin hole 48 which receives guide pin or follower 50 preferably located on a tip portion 116 of blade 112. Guide pin 50 is preferably press fit into hole 48 in blade 112 of cutting device 110, although it also could be attached by other means such as welding, or even formed as a part of blade 112, in which cases hole 48 may be unnecessary. Guide pin 50 could even comprise a plurality of guide pins (e.g., two) located independent of one another depending on the application and the design of the mating components. Blade 112 of cutting device 110 is preferably made from stainless steel, although many other materials may also be used depending, of course, on the acceptability of the material's properties for the given application.

Cutting device 110 may be inserted and stored in CDPM 120 once CDPM 120 is properly attached to base 12, and handle 42 may provide functionality as a stop. The location and position of guide pin 50 on blade 112 helps to prevent improper assembly of cutting device 110 to CDPM 120 and also influences the specific amount and shape of the cutting action of cutting device 100. The cutting/slicing edge portion 114 of cutting device 110 may include features such as but not limited to serrations to improve or enhance the performance of cutting device 100 for a given application.

Cutting device 110 may comprise more than one section of cutting/slicing edge (not shown) that can be either the same, or more likely different than cutting edge 114, may be located along the long edge opposite of and parallel to cutting edge 114, and will allow cutting device 110 to provide additional cutting and slicing features or longevity. This enhanced version of cutting device 100 could be used in a rotated orientation compared to the default position of cutting device 110 if handle 42 is appropriately formed and if hole 48 and guide pin 50 were appropriately located.

Cutting device 110 may be implemented in other ways including but not limited to similar to a coping saw consisting of a thin, light blade or wire held under tension, in a U-shaped frame that includes an appropriate modification to handle 42, or also as an electric knife with appropriate modifications as long as cutting device 110 maintains the appropriate interaction with front camming edge 126 on spacer 124 and its interaction with modified tip portion 116 of blade 112 on cutting device 110. The design of the various components of cutting device 110 may again vary depending on the particular application without departing from the spirit of the invention.

CDPM 120 provides functionality as a slotted guide and it comprises a channel 136 and a control track 128 to retain and guide cutting device 110 through being proximate guide pin or follower 50 of cutting device 110 and to guide and control the various cutting and slicing motions of cutting device 110. In this embodiment, CDPM 120 comprises three primary components: two complementary slotted guides 122a and 122b and spacer bar 124 in between. Slotted guides 122a and 122b provide mechanical strength to CDPM 120. Spacer bar 124 could also be integrated into slotted guide 122a or 122b. These three components are held together in this embodiment by a plurality of slotted pins 66 that are preferably made of a compatible metal, and can be welded, press fit, molded, cast, etc. to at least one of slotted guides 62a and 62b, and each mate with a corresponding keyhole 66a in the other slotted guide 62a and 62b. The three components 122a, 122b and 124 and pins 66 are preferably made from a material such as but not limited to 300-series stainless steel, which has a higher nickel and chrome content. The design of these three primary components of CDPM 120 improves the ease of safely inserting cutting device 110 into CDPM 120. CDPM 120 is designed to be readily assembled and disassembled to allow the components to be easily yet thoroughly cleaned and dishwasher safe.

It is preferable that the width of spacer 124 be wide enough so that inner surfaces of slotted guides 122a and 122b are spaced apart a sufficient distance to form channel 136 and avoid having cutting device 110 bind against slotted guides 122a and 122b, but not so loose that there is a significant amount of “play”, “wobble” or rotational movement/twisting of cutting device 110. The width of spacer 124 can be adjusted to accommodate cutting devices 110 of various widths.

The design of control track 128 again provides a significant improvement over the prior art defined hereinabove. Control track 128 is preferably located in at least one of one of the two slotted guides 122a and 122b and it can be formed in many ways including etching, milling, and as part of a casting process.

In this embodiment control track 128 provides a path comprising an opening 130 that allows guide pin 50 of cutting device 110 to be inserted onto control track 128. Once guide pin/follower 50 on tip portion 116 of cutting device 110 is inserted into opening 130 of CDPM 120, pin/follower 50 may be moved along track 128 between the plurality of catches or detents 132 and 132a thereby allowing cutting device 110 controlled passage by a user through channel 136 formed between slotted guides 122a and 122b. In this embodiment opening 130 is located on the top surface of CDPM 120, but locating it on a different surface is also possible without departing from the spirit of the invention.

The preferred “shape” of track 128, including the “width” or spacing of catches/detents 132 and 132a, is designed so that pin/follower 50 on cutting device 110 can move along track 128 in a controlled fashion and will neither bind nor twist along the desired or preferred path and between and into catches/detents 132 and 132a, thus allowing cutting device 110 to easily and safely pivot around pin 50 and accomplish the task at hand. The width of control track 128 does not need to be perfectly uniform in width, but it should be uniform enough that the pin/follower 50 does not come out of track 128 when cutting device 110 is inserted into CDPM 120.

A preferred overall “shape” for track 128 including catches/detents 132 and 132a is to have fairly rounded curves that allow pin/follower 50 to be able to smoothly engage and disengage catch/detent 132 and 132a and not be inadvertently disengaged or forced out while the user is attempting to slice an object with cutting device 110.

The shape and length of catch/detent 132a is of additional significance because in addition to allowing cutting device 110 to operate in a slicing motion around a pivot point as in the other catches/detents 132, it impacts the length and shape of the stroke of the primarily horizontal “sawing” or cutting motion that cutting device 110 is allowed.

In this embodiment control track 128 of CDPM 120 comprises only one catch/detent 132a that has an elongated slot that allows both slicing and cutting of an object. It should be understood that control track 128 could include multiple catches/detents 132 and/or catches/detents 132a with different spacing, length or shape slots, or other modifications to tailor device 100 to better accomplish specific applications without departing from the spirit of the invention.

An important advantage of the design of CDPM 120 over the prior art is the capability of CDPM 120 to ensure that when pin 50 of cutting device 110 is positioned in one of catches or detents 132 or 132a, an additional component such as a “stop member” (as previously discussed hereinabove) is not necessary to hold guide pin 50 within one of catches or detents 132 or 132a for cutting device 110 to operate effectively and efficiently.

As in the first embodiment, each slotted guide 122a and 122b has a respective base portion 140a and 140b perpendicular to respective substantially vertically standing portion 142a and 142b, and base portions 140a and 140b each comprise two keyholes 68. The assembled CDPM 120 is removably secured to board 12 by positioning the larger portion 68a of keyholes 68 in respective base portion 140a and 140b of slotted guides 122a and 122b of CDPM 120 over corresponding base pins 32 in board 12. CDPM 120 is engaged and retained by retention tab 68c, which is included in at least one keyhole 68, by moving CDPM 120 relative to board 12 until necked down region 36 of base pins 32 are positioned in the smaller portion 68b of keyholes 68. Thus, once properly attached, CDPM 120 is in proper position to allow the insertion of cutting device 110 and for the proper functioning of device 100. Other ways of the aligning and retaining CDPM 120 to board 12 should be apparent to those skilled in the art without departing from the spirit of the overall invention. CDPM 120 may optionally include a feature (not shown) where board 12 is designed so that CDPM 120 cannot be attached to board 12 if cutting device 110 is already inserted in CDPM 120. CDPM 120 may also be attachable to a portion of board 12 that is rotatable (a feature not shown in this embodiment) to allow an angular cutting and slicing action.

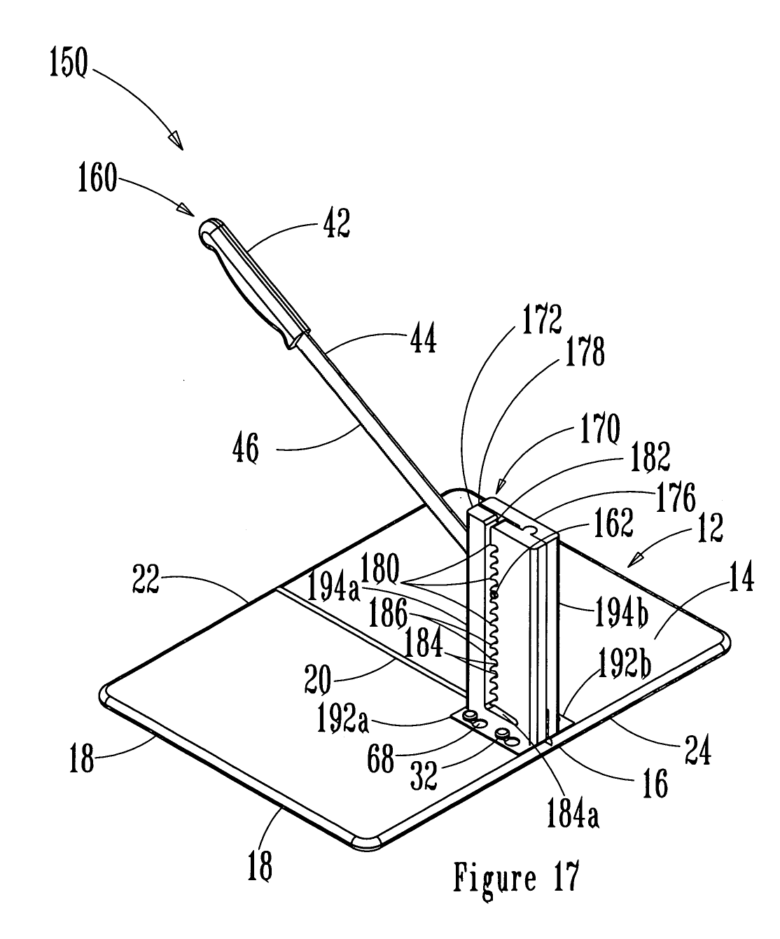

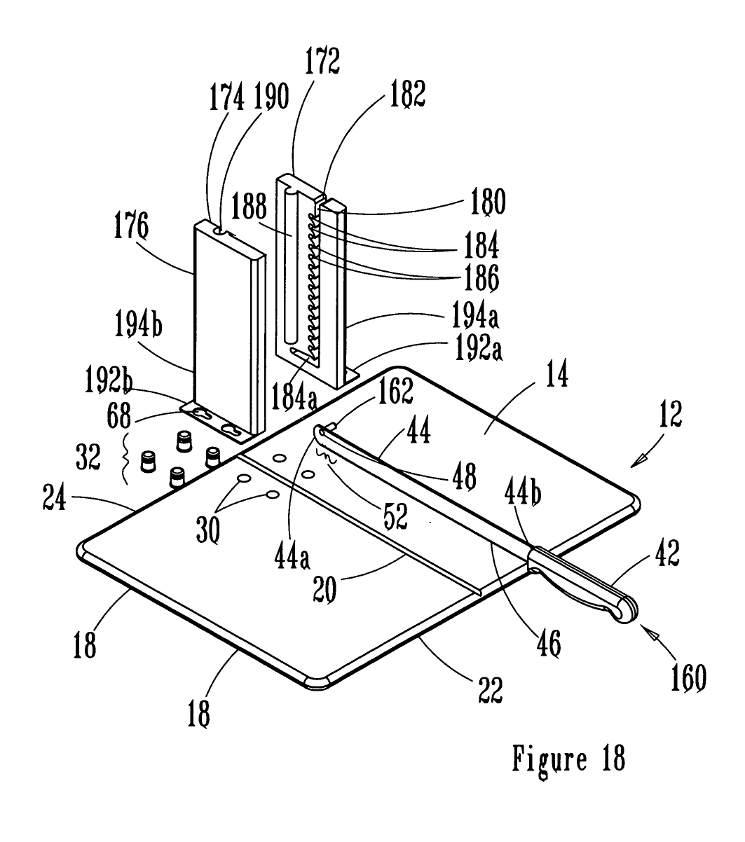

Referring now to FIG. 17, there is shown a perspective view of a device 150 to cut or slice items such as produce safely and efficiently and be easily disassembled for cleaning in accordance with a third embodiment of the present invention. Device 150 (see FIGS. 17-18) is designed to reliably keep a cutting device 160 in an upright position when no external forces are applied to the cutting device, thereby providing a safety feature whereby a cutting device 160 should never act as a guillotine and fall downwardly under the force of gravity alone and potentially causing injury to the user. Since device 150 shares many similarities with device 10, many components used in this embodiment have the same numbers as in the first embodiment also share the characteristics, materials, options, permutations, etc. of those components as well.

As with device 10, device 150 comprises three primary components, a cutting board 12, a cutting device positioning member (CDPM) 170, and a cutting device (CD) 160. A primary goal of this embodiment is to modify the design of CDPM 170 and cutting device 160 to offer a possible cost reduction for certain applications. Generally speaking, the design modifications are accomplished by increasing the length of a guide pin/follower 162 and having it protrude from only one side of cutting device 160, and having CDPM 170 comprise as many components as possible made from a material such as a plastic (preferably injection moldable), and have only one slotted guide 172 that includes a control track 180 similar to control track 70 in device 10 but “deeper” to compensate for the longer length of guide pin/follower 162. This allows a retainer 176 (the component of CDPM 170 on the other of cutting device 160 and a spacer 174) to be greatly simplified, preferably requiring only a primarily flat piece that is readily connectable but still separable from slotted guide 172 to ensure that the components of CDPM 170 can still be readily assembled and disassembled to be easily yet thoroughly cleaned and dishwasher safe. Spacer 174 may preferably be formed as a part of either slotted guide 172 or retainer 176.

The width of spacer 174 can be adjusted to accommodate cutting devices 160 of various widths. It is preferable that the width of spacer 174 be wide enough so that inner surfaces of slotted guide 172 and retainer 176 are spaced apart a sufficient distance to form channel 178 and avoid having cutting device 160 bind against slotted guide 172 and retainer 176, but not so loose that there is a significant amount of “play”, “wobble” or rotational movement/twisting of cutting device 160. Also, the longer guide pin/follower 162 and corresponding control track 180 help to compensate for having a track on only one side of cutting device 160 while still minimizing rotational movement/twisting of cutting device 160.

The design of control track 180 provides a significant improvement over the prior art defined hereinabove. Control track 180 is preferably formed as a part of the molding process of slotted guide 172. In this embodiment control track 180 provides a path comprising an opening 182 that allows guide pin 162 of cutting device 160 to be inserted onto control track 180. The design of opening 182 is intended to make it easier for CDPM 170 to receive guide pin/follower 162 on tip portion 52 of cutting device 160. Once guide pin/follower 162 on tip portion 52 of cutting device 160 is inserted into opening 182 of CDPM 170, pin/follower 162 may be moved along track 180 between the plurality of catches or detents 184 and 184a thereby allowing cutting device 160 controlled passage by a user through channel 178 formed between slotted guide 172 and retainer 176. In this embodiment opening 182 is located on the top surface of CDPM 170, but locating it on a different surface or adding an additional opening is also possible without departing from the spirit of the invention. For example, an additional opening 182a (not shown) could be added on CDPM 170 preferably far away from opening 182 on the outer surface of CDPM 170 facing the user and the object to be sliced or cut. Additional opening 182a allows cutting device 160 to be easily inserted without needing to lift pin 162 of cutting device 160 as high vertically. And while cutting device 160 may also be removed through opening 182a, it is preferable for opening 182a to have retentive means, for example, a stop (not shown), to avoid the inadvertent removal of cutting device 160 from control track 180 of CDPM 170.

The preferred “shape” of track 180, including the “width” or spacing of catches/detents 184 and 184a, is designed so that pin/follower 162 on cutting device 160 can move along track 180 in a controlled fashion and will neither bind nor twist along the desired or preferred path and between and into catches/detents 184 and 184a, thus allowing cutting device 160 to easily and safely pivot around pin 162 and accomplish the task at hand. The width of control track 180 does not need to be perfectly uniform in width, but it should be uniform enough that the pin/follower 162 does not come out of track 180 when cutting device 160 is inserted into CDPM 170.

A preferred overall “shape” for track 180 including catches/detents 184 and 184a is to have fairly rounded curves that allow pin/follower 162 to be able to smoothly engage and disengage catch/detent 184 and 184a and not be inadvertently disengaged or forced out while the user is attempting to slice an object with cutting device 160. But it is also preferable that the entry portion of catches/detents 184 and 184a comprise a tooth 186 with a claw hook-shaped portion located to help retain guide pin/follower 162 once engaged within a particular catch/detent 184 and 184a. Spaced teeth 186 and catches/detents 184 and 184a may be cleaned of any foodstuff that may accumulate during cutting or slicing once CDPM 170 is disassembled.

The shape and length of catch/detent 184a is of additional significance because in addition to allowing cutting device 160 to operate in a slicing motion around a pivot point as in the other catches/detents 184, it impacts the length and shape of the stroke of the primarily horizontal “sawing” or cutting motion that cutting device 160 is allowed.

In this embodiment control track 180 of CDPM 170 comprises only one catch/detent 184a that has an elongated slot that allows both slicing and cutting of an object. It should be understood that control track 180 could include multiple catches/detents 184 and/or catches/detents 184a with different spacing, length or shape slots, or other modifications to tailor device 150 to better accomplish specific applications without departing from the spirit of the invention.

Cutting device 160 comprises a handle or other gripping means 42, and a blade 44 having a first end 44a and a second end 44b, and a first side 44c and a second side 44d. A cutting edge 46 that is preferably serrated is provided along an edge of blade 44, and blade 44 has at least one guide pin hole 48 which receives guide pin or follower 162 preferably located on a tip portion 52 of blade 44. Guide pin 162 is preferably press fit into hole 48 in blade 44 of cutting device 160, although it also could be attached by other means such as welding, or even formed as a part of blade 44, in which cases hole 48 may be unnecessary. As stated hereinabove, lengthened guide pin/follower 162 in this embodiment protrudes from only one side of cutting device 160. Blade 44 of cutting device 160 is preferably made from stainless steel, although many other materials may also be used depending, of course, on the acceptability of the material's properties for the given application.

Cutting device 160 may be inserted and stored in CDPM 170 once CDPM 170 is properly attached to base 12, and handle 42 may provide functionality as a stop. The location and position of guide pin 162 on blade 44 helps to prevent improper assembly of cutting device 160 to CDPM 170 and also influences the specific amount and shape of the cutting action of cutting device 160.

The cutting/slicing edge portion 46 of cutting device 160 may include features such as but not limited to serrations to improve or enhance the performance of cutting device 160 for a given application.

Cutting device 160 may comprise more than one section of cutting/slicing edge (not shown) that can be either the same, or more likely different than cutting edge 46, may be located along the long edge opposite of and parallel to cutting edge 46, and will allow cutting device 160 to provide additional cutting and slicing features or longevity. This enhanced version of cutting device 160 could be used in a rotated orientation compared to the default position of cutting device 160 if handle 42 is appropriately formed and if hole 48 and guide pin 162 were appropriately located.

It may also be desirable that pin 162 be part of a unit attachable to a standard knife (not shown), thus allowing the user the freedom to choose from a wider range of existing cutting devices as long as the new cutting device is dimensionally compatible with CDPM 170.

Cutting device 160 may be implemented in other ways including but not limited to similar to a coping saw consisting of a thin, light blade or wire held under tension, in a U-shaped frame that includes an appropriate modification to handle 42, or also as an electric knife with appropriate modifications.

The design of the various components of cutting device 160 may vary depending on the particular application without departing from the spirit of the invention.

CDPM 170 provides functionality as a slotted guide and it comprises a channel 178 and a control track 180 to retain and guide cutting device 160 through being proximate guide pin or follower 162 of cutting device 160 and to guide and control the various cutting and slicing motions of cutting device 160. In this embodiment, CDPM 170 comprises three primary components: slotted guide 172, retainer 176 and spacer bar 174 in between, which provide mechanical strength to CDPM 170. In this embodiment spacer bar 174 is integrated into and formed as a part of retainer 176. While these three components may be held together by a plurality of slotted pins as shown in previous embodiments, this time a retentive, modified tongue and groove joint approach is used, with slotted guide 172 comprising a male portion 188 with an appropriate radius and a given length, and retainer 176 comprising a female portion 190 preferably with a matching length, thus allowing CDPM 170 to be easily assembled by sliding male portion 188 of slotted guide 172 into female portion 190 of retainer 176. The design of the primary components of CDPM 170 improves the ease of safely inserting cutting device 160 into CDPM 170. CDPM 170 is designed to be readily assembled and disassembled to allow the components to be easily yet thoroughly cleaned and dishwasher safe.

An important advantage of the design of CDPM 170 over the prior art is the capability of CDPM 170 to ensure that when pin 162 of cutting device 160 is positioned in one of catches or detents 184 or 184a, an additional component such as a “stop member” (as previously discussed hereinabove) is not necessary to hold guide pin 162 within one of catches or detents 184 or 184a for cutting device 160 to operate effectively and efficiently.

In this embodiment slotted guide 172 and retainer 176 have a respective base portion 192a and 192b perpendicular to a respective substantially vertically standing portion 194a and 194b, and base portions 192a and 192b each comprise two keyholes 68. Base portions 192a and 192b may be formed as part of slotted guide 172 and retainer 176 respectively, but may also be made of a material such as metal as in the first two embodiments or even a different material and incorporated/included as part of the formation of respective slotted guide 172 and retainer 176.

The assembled CDPM 170 may be removably secured to board 12 by moving it relative to board 12 until it is engaged, retained and properly attached to board 12 to allow the insertion of cutting device 160 and for the proper functioning of device 150 by means as described in the previous embodiments (i.e., by positioning the larger portion of keyholes 68 in respective base portion 192a and 192b of slotted guide 172 and retainer 176 of CDPM 170 over corresponding base pins 32 in board 12 and then moving CDPM 170 relative to board 12 until necked down region 36 of base pins 32 are positioned in the smaller portion 68b of keyholes 68 until CDPM 170 is engaged and retained by retention tab 68c, which is included in at least one keyhole 68) or by other compatible means. Other ways of the aligning and retaining CDPM 170 to board 12 should be apparent to those skilled in the art without departing from the spirit of the overall invention. CDPM 170 may optionally include a feature (not shown) where board 12 is designed so that CDPM 170 cannot be attached to board 12 if cutting device 160 is already inserted in CDPM 170. CDPM 170 may also be attachable to a portion of board 12 that is rotatable (a feature not shown in this embodiment) to allow an angular cutting and slicing action.

CDPM 170 may optionally include an outer cover 196 (not shown) around CDPM 170. CDPM 170 may also include a safety latch (not shown) to ensure that when cutting device 160 is in a resting position, it cannot be inadvertently removed.

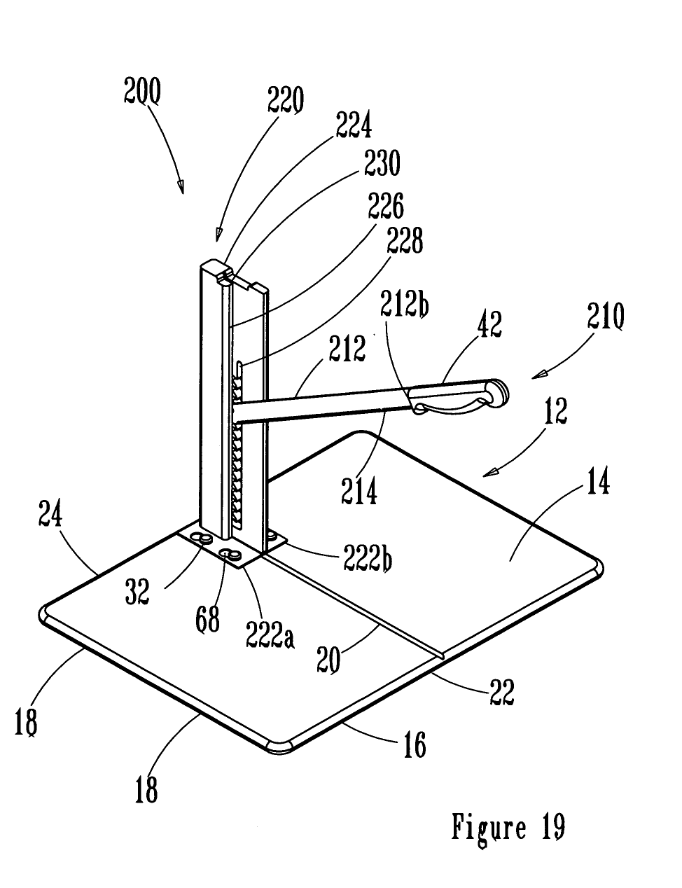

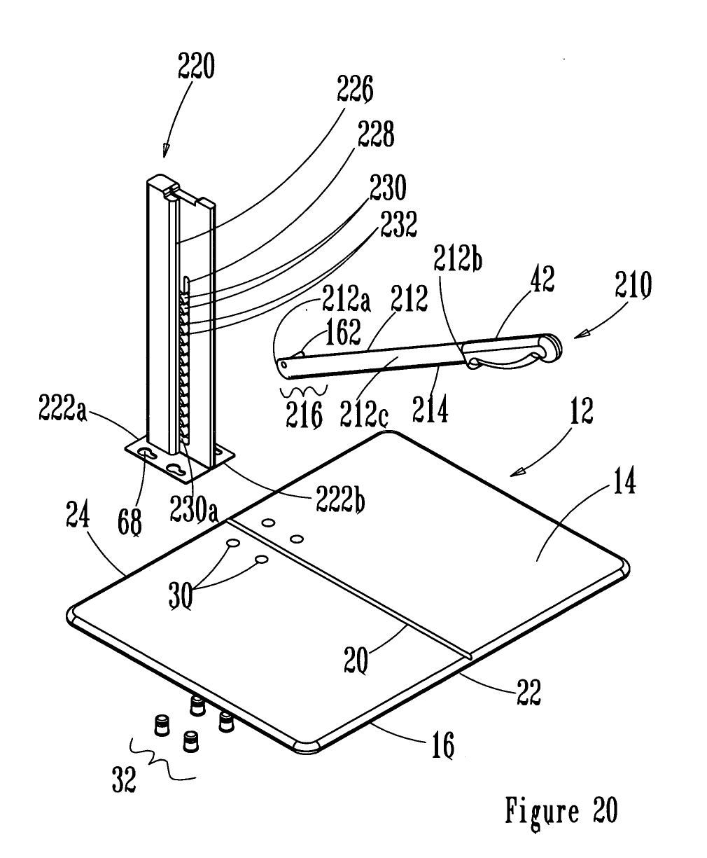

Referring now to FIG. 19, there is shown a perspective view of a device 200 to cut or slice items such as produce safely and efficiently and be easily disassembled for cleaning in accordance with a fourth embodiment of the present invention. Device 200 (see FIGS. 19-20) is designed to reliably keep a cutting device 210 in an upright position when no external forces are applied to the cutting device, thereby providing a safety feature whereby a cutting device 210 should never act as a guillotine and fall downwardly under the force of gravity alone and potentially causing injury to the user. Device 200 shares many similarities, characteristics and design goals with device 150.

As with device 150, device 200 comprises three primary components, a cutting board 12, a cutting device positioning member (CDPM) 220, and a cutting device (CD) 210. A primary goal of this embodiment is to modify the design of CDPM 170 and cutting device 160 to offer further potential cost reductions for certain applications. The design modifications of device 150 of increasing the length of a guide pin/follower and having it protrude from only one side of a cutting device, having a CDPM comprise as many components as possible made from a material such as a plastic (preferably injection moldable), and have only one slotted guide that includes a “deeper” control track to compensate for the longer length of the guide pin/follower are again included in this embodiment. But in this embodiment, CDPM 220 is preferably formed as one molded structure, other than a small number of components or features such as but not limited to base portion 222a and 222b (each comprising keyholes 68 and which may comprise materials similar to base portion 192a and 192b of the third embodiment) to further simplify the design and potentially reduce costs. CDPM 220 is designed with generous radii on “hidden” or hard to reach areas, particularly on channel 226 and control track 228 to minimize the possibility of trapping food or other debris, thus allowed CDPM 220 to be thoroughly and properly cleaned.

Cutting device 210 comprises a handle or other gripping means 42, and a blade 212 having a first end 212a and a second end 212b, and a first side 212c and a second side 212d. A cutting edge 214 that is preferably serrated is provided along an edge of blade 212, and blade 212 has at least one guide pin hole 48 which receives guide pin or follower 162 preferably located on a tip portion 216 of blade 212. Guide pin 162 is preferably press fit into hole 48 in blade 212 of cutting device 210, although it also could be attached by other means such as welding, or even formed as a part of blade 212, in which cases hole 48 may be unnecessary. As stated hereinabove, lengthened guide pin/follower 162 in this embodiment protrudes from only one side of cutting device 210. Blade 212 of cutting device 210 is preferably made from stainless steel, although many other materials may also be used depending, of course, on the acceptability of the material's properties for the given application.

Cutting device 210 is a variation of cutting device 160, with the primary difference being the shape of a tip portion 216. Tip portion 216 of blade 212 of cutting device 210 is formed so that if a handle 42 of cutting device 210 is moved to a mostly vertical position, cutting device 210, including guide pin/follower 162, may be inserted into or removed from a control track 228 on CDPM 220.

It is preferable that the width of a channel 226 be wide enough so that inner surfaces are spaced apart a sufficient distance to avoid having cutting device 210 bind against the inner surfaces, but not so loose that there is a significant amount of “play”, “wobble” or rotational movement/twisting of cutting device 210. Also, the longer guide pin/follower 162 and corresponding control track 228 help to compensate for having a track on only one side of cutting device 210 while still minimizing rotational movement/twisting of cutting device 210.

The design of control track 228 provides a significant improvement over the prior art defined hereinabove. Control track 228 is preferably formed as a part of the molding process of CDPM 220. In this embodiment control track 228 provides a path that allows guide pin 162 of cutting device 210 to be inserted onto control track 228. Once guide pin/follower 162 on tip portion 216 of cutting device 210 is inserted into control track 228 of CDPM 220, pin/follower 162 may be moved along track 228 between the plurality of catches or detents 230 and 230a thereby allowing cutting device 210 controlled passage by a user through channel 226.

The preferred “shape” of track 228, including the “width” or spacing of catches/detents 230 and 230a, is designed so that pin/follower 162 on cutting device 210 can move along track 228 in a controlled fashion and will neither bind nor twist along the desired or preferred path and between and into catches/detents 230 and 230a, thus allowing cutting device 210 to easily and safely pivot around pin 162 and accomplish the task at hand. The width of control track 228 does not need to be perfectly uniform in width, but it should be uniform enough that the pin/follower 162 does not inadvertently come out of track 228 when cutting device 210 is inserted into CDPM 220.

A preferred overall “shape” for track 228 including catches/detents 230 and 230a is to have fairly rounded curves that allow pin/follower 162 to be able to smoothly engage and disengage catch/detent 230 and 230a and not be inadvertently disengaged or forced out while the user is attempting to slice an object with cutting device 210. But it is also preferable that the entry portion of catches/detents 230 and 230a comprise a tooth 232 with a claw hook-shaped portion located to help retain guide pin/follower 162 once engaged within a particular catch/detent 230 and 230a. Spaced teeth 232 and catches/detents 230 and 230a may be cleaned of any foodstuff that may accumulate during cutting or slicing once CDPM 220 is removed for cleaning.

The shape and length of catch/detent 230a is of additional significance because in addition to allowing cutting device 210 to operate in a slicing motion around a pivot point as in the other catches/detents 230, it impacts the length and shape of the stroke of the primarily horizontal “sawing” or cutting motion that cutting device 210 is allowed.

In this embodiment control track 228 of CDPM 220 comprises only one catch/detent 230a that has an elongated slot that allows both slicing and cutting of an object. It should be understood that control track 228 could include multiple catches/detents 230 and/or catches/detents 230a with different spacing, length or shape slots, or other modifications to tailor device 200 to better accomplish specific applications without departing from the spirit of the invention.

Cutting device 210 may be inserted and stored in CDPM 220 once CDPM 220 is properly attached to base 12, and handle 42 may provide functionality as a stop. The location and position of guide pin 162 on blade 212 helps to prevent improper assembly of cutting device 210 to CDPM 220 and also influences the specific amount and shape of the cutting action of cutting device 210.

The cutting/slicing edge portion 214 of cutting device 210 may include features such as but not limited to serrations to improve or enhance the performance of cutting device 210 for a given application.

Cutting device 210 may comprise more than one section of cutting/slicing edge (not shown) that can be either the same, or more likely different than cutting edge 46, may be located along the long edge opposite of and parallel to cutting edge 46, and will allow cutting device 160 to provide additional cutting and slicing features or longevity. This enhanced version of cutting device 160 could be used in a rotated orientation compared to the default position of cutting device 210 if handle 42 is appropriately formed and if hole 48 and guide pin 162 were appropriately located.

It may also be desirable that pin 162 be part of a unit attachable to a standard knife (not shown), thus allowing the user the freedom to choose from a wider range of existing cutting devices as long as the new cutting device is dimensionally compatible with CDPM 220.

Cutting device 210 may be implemented in other ways including but not limited to similar to a coping saw consisting of a thin, light blade or wire held under tension, in a U-shaped frame that includes an appropriate modification to handle 42, or also as an electric knife with appropriate modifications.

The design of the various components of cutting device 210 may vary depending on the particular application without departing from the spirit of the invention.

CDPM 220 provides functionality as a slotted guide and it comprises a channel 226 and a control track 228 to retain and guide cutting device 210 through being proximate guide pin or follower 162 of cutting device 210 and to guide and control the various cutting and slicing motions of cutting device 210.

An important advantage of the design of CDPM 220 over the prior art is the capability of CDPM 220 to ensure that when pin 162 of cutting device 210 is positioned in one of catches or detents 230 or 230a, an additional component such as a “stop member” (as previously discussed hereinabove) is not necessary to hold guide pin 162 within one of catches or detents 230 or 230a for cutting device 210 to operate effectively and efficiently.

In this embodiment CDPM 220 comprises base portion 222a and 222b, and base portions 222a and 222b each comprise two keyholes 68. Base portions 222a and 222b may be formed as part of CDPM 220, but may also be made of a material such as metal as in the first two embodiments or even a different material and then incorporated into or included as part of the formation of CDPM 220.

The assembled CDPM 220 may be removably secured to board 12 by moving it relative to board 12 until it is engaged, retained and properly attached to board 12 to allow the insertion of cutting device 210 and for the proper functioning of device 200 by means as described in the previous embodiments (i.e., by positioning the larger portion of keyholes 68 in base portions 222a and 222b of CDPM 220 over corresponding base pins 32 in board 12 and then moving CDPM 220 relative to board 12 until necked down region 36 of base pins 32 are positioned in the smaller portion 68b of keyholes 68 until CDPM 220 is engaged and retained by retention tab 68c, which is included in at least one keyhole 68) or by other compatible means. Other ways of the aligning and retaining CDPM 220 to board 12 should be apparent to those skilled in the art without departing from the spirit of the overall invention. CDPM 220 may optionally include a feature (not shown) where board 12 is designed so that CDPM 220 cannot be attached to board 12 if cutting device 210 is already inserted in CDPM 220. CDPM 220 may also be attachable to a portion of board 12 that is rotatable (a feature not shown in this embodiment) to allow an angular cutting and slicing action. CDPM 220 may optionally include an outer cover 234 (not shown) around CDPM 220. CDPM 220 may also include a safety latch (not shown) to ensure that when cutting device 210 is in a resting position, it cannot be inadvertently removed.

While many of the abovementioned cutting devices preferably comprise a guide pin/follower attached to at least one side of or through the sides of a blade, it should be understood that a cutting device with at least one hole, at least partially through the blade, would allow a user to insert the blade into the channel, and to align the hole on the blade of the cutting device with a catch/detent or a control track of a CDPM, and to have the user insert the guide pin/follower to allow the catch/detent or control track to capture and be proximate the guide pin/follower and the blade of the cutting device, and to allow the blade to travel along the channel, and the guide pin to travel along the control track and catches/detents to guide and control the various cutting and slicing motions of the cutting device. In this case, an opening connected to the control path could still be useful but not necessarily required. Also, as stated hereinabove, spacers of varying thicknesses could be used to optimize the performance of the cutting device and the overall device depending on the thickness of a particular blade. These various options and permutations allow not only a plurality of innovative slicing and cutting devices, but also slicing and cutting devices or “systems” with modularity previously unavailable.

While the abovementioned devices are disclosed comprising a board, a cutting device, and a CDPM, it should be understood that a plurality of modular, slicing and/or cutting systems could potentially be assembled using other cutting devices and boards or bases, but comprising the novel, disclosed CDPMs with any or all of the various permutations disclosed hereinabove.

It should be understood that a “user” of the innovative devices disclosed hereinabove includes not only humans, but also robotic means, mechanical and electro-mechanical devices as well as other devices yet to be invented.

Since other modifications and changes varied to fit particular operating requirements and environments will be apparent to those skilled in the art, this invention is not considered limited to the representative examples chosen for purposes of this disclosure, and covers all changes and modifications which do not constitute departures from the true spirit and scope of this invention.

Having thus described the invention, what is desired to be protected by Letters Patent is presented in the subsequently appended claims.

What is claimed is:

1. A device for slicing an object, the device comprising:
a) a cutting device (CD) comprising an elongated blade having a major axis, an anterior end, a posterior end, and a cutting edge extending along said major axis at least partially between said anterior end and said posterior end, and a first side and a second side parallel to said major axis;
b) a cutting board having an upper major surface for receiving an object to be sliced;
c) a cutting device positioning member (CDPM) removably secured to and projecting upwardly from said upper surface of said board, and comprising within said CDPM a control track, at least one catch/detent, and a channel open to an external surface of said CDPM; and
d) a guide pin protruding from at least one of said first and second sides of said blade;
wherein once said device is assembled, said guide pin is proximate said blade of said cutting device and said control track of said CDPM, said blade of said cutting device being allowed to travel along said channel, and once said guide pin is selectively engaged in said at least one catch/detent, said CDPM guides and controls at least one slicing motion of said cutting device.

2. The device as recited in claim 1, wherein at least one of said at least one catch/detent further comprises a tooth with a claw hook-shaped portion located to facilitate retention of said guide pin once said guide pin is engaged within said at least one of said at least one catch/detent.

3. The device as recited in claim 1, wherein at least one of said at least one catch/detent further comprises an elongated slot to allow said guide pin longer travel within said at least one catch/detent than compared to a catch/detent having a non-elongated slot, thereby allowing said cutting device to be operated in a saw-like cutting motion to cut an object.

4. The device as recited in claim 1, wherein at least said cutting edge of said blade of said cutting device may be retained completely within said CDPM when said device is not it use.

5. The device as recited in claim 1, wherein said CDPM further comprises a spacer bar comprising a front-facing camming edge, and said blade of said cutting device comprises a tip portion, and where said front-facing camming edge and said tip portion interact as said guide pin travels along said channel and is selectively engaged in said at least one catch/detent to provide a camming action.

6. The device as recited in claim 1, wherein said cutting board further comprises at least one chosen from the group: a trough, a groove, a handle, a plurality of feet, measuring means, and a rotatable portion.

7. The device as recited in claim 1, wherein said cutting device further comprises at least one chosen from the group: a cutting device comprising a handle, a cutting device comprising gripping means, a cutting device comprising a second cutting edge, and an electric knife.

8. The device as recited in claim 1, wherein said CDPM further comprises at least one chosen from the group: a keyed base portion, a spacer bar, and an outer cover.

9. The device as recited in claim 1, wherein said control track further comprises an opening to an external surface of said CDPM.

10. The device as recited in claim 1, wherein once said CDPM is removably secured to said board, said CDPM is positioned primarily perpendicular to said board.

11. The device as recited in claim 1, wherein said CDPM is removed from said board, said CDPM is disassemblable.

12. The device as recited in claim 1, wherein said guide pin is removable from said blade of said cutting device.

13. A cutting device positioning member (CDPM) for use with a base and a cutting device for slicing an object, the CDPM comprising:
a) a control track within said CDPM and further comprising at least one catch/detent; and
b) a channel open to an external surface of said CDPM;
wherein once a guide pin is inserted proximate a blade of a cutting device and said control track of said CDPM, said blade of said cutting device being allowed to travel along said channel, and once said guide pin is selectively engaged in said at least one catch/detent, said CDPM guides and controls at least one slicing motions of said cutting device.

14. The CDPM as recited in claim 13, wherein said CDPM is removably securable to a base.

15. The CDPM as recited in claim 13, wherein said control track further comprises an opening to an external surface of said CDPM.

16. The CDPM as recited in claim 13, wherein said CDPM is disassemblable.

17. The CDPM as recited in claim 13, wherein at least one of said at least one catch/detent further comprises a tooth with a claw hook-shaped portion located to facilitate retention of said guide pin once said guide pin is engaged within said at least one of said at least one catch/detent.

18. The CDPM as recited in claim 13, wherein at least one of said at least one catch/detent further comprises an elongated slot to allow said guide pin longer travel within said at least one catch/detent than compared to a catch/detent having a non-elongated slot, thereby allowing said cutting device to be operated in a saw-like cutting motion to cut an object.

19. The CDPM as recited in claim 13, wherein said CDPM further comprises a spacer bar comprising a front-facing camming edge, and said blade of said cutting device comprises a tip portion, and where said front-facing camming edge and said tip portion interact as said guide pin travels along said channel and is selectively engaged in said at least one catch/detent to provide a camming action.

20. The CDPM as recited in claim 13, wherein said CDPM further comprises at least one chosen from the group: a keyed base portion, a removably securable base portion, a spacer bar, and an outer cover.
